(19) United States
(12) Patent Application Publication
(10) Pub. No.: US 2026/0314787 A1
(43) Pub. Date: Oct. 15, 2026

(54) HAIR CLIP

(71) Applicant: DEEP POINT Co., Ltd., Seoul (KR)

(72) Inventor: Dong Jun LEE, Seoul (KR)

(73) Assignee: DEEP POINT Co., Ltd., Seoul (KR)

(21) Appl. No.: 19/641,759

(22) Filed: Apr. 8, 2026

(30) Foreign Application Priority Data
Apr. 9, 2025 (KR) 10-2025-0046198

(51) Int. Cl. A45D 8/12

(52) U.S. Cl. CPC A45D 8/12

(57) ABSTRACT

A hair clip is disclosed. The hair clip includes a plurality of upper base members each extending obliquely and disposed adjacent to each other at intervals in a left-right direction, a plurality of lower base members disposed below the plurality of upper base members, and a plurality of comb teeth protruding downward from each of the plurality of upper base members and the plurality of lower base members. The plurality of lower base members extends to cross an extension direction of the plurality of upper base members and being disposed adjacent to each other at intervals in the left-right direction. At least one of the plurality of lower base members has one end hingedly coupled to one end of one of the plurality of upper base members and the other end hingedly coupled to the other end of another one of the plurality of upper base members.

### CROSS-REFERENCE TO RELATED APPLICATION

This application claims priority to and the benefit of Korean Patent Application No. 10-2025-0046198, filed on Apr. 9, 2025, the disclosure of which is incorporated herein by reference in its entirety.

### BACKGROUND

### 1. Field of the Invention

The present disclosure relates to a hair clip.

### 2. Discussion of Related Art

Generally, human hair grows at a certain angle from the scalp and tends to curve in a uniform direction, thereby creating a specific hair growth pattern.

For this reason, it is difficult for hair to naturally maintain volume, making it challenging for individuals to achieve their desired hairstyles. Furthermore, individuals with a lower hair growth angle experience hair that lies flat against the scalp, resulting in a sunken appearance that further complicates styling. Such issues become more pronounced with age-related hair loss, often causing significant concern and stress for the individual.

To address these volume-related issues, various tools such as hairpins or hair rollers have been introduced. However, conventional tools used for root volume treatments have a drawback in that it is difficult to correct the hair closely to the hair follicles—that is, the portion near the roots of the hair.

Additionally, when setting a hairstyle using a conventional hairdryer, a brush or similar tool is typically required. This process involves holding the hairdryer in one hand to apply heat while manipulating the brush with the other hand while looking in a mirror. Such an operation is difficult and cumbersome. Consequently, temporary styling methods using a hairdryer often fail to yield the desired results unless performed by a professional.

Accordingly, there has been a continuous need for a tool that can more easily enhance the root volume of hair compared to conventional methods.

The background technology related to the present disclosure is disclosed in Korean Patent Publication No. 10-2021-0011674.

### SUMMARY OF THE INVENTION

An object of the present disclosure is to provide a hair clip capable of enhancing root volume of hair more easily and effectively than conventional methods.

However, the technical problems to be achieved by the embodiments of the present disclosure are not limited to the technical problems described above, and other technical problems may exist.

According to an embodiment of the present disclosure, a hair clip includes: a plurality of upper base members, each extending obliquely and disposed adjacent to each other in a left-right direction at intervals; a plurality of lower base members disposed below the plurality of upper base members, the plurality of lower base members extending to cross an extension direction of the plurality of upper base members and being disposed adjacent to each other in the left-right direction at intervals; and a plurality of comb teeth protruding downward from each of the plurality of upper base members and the plurality of lower base members. To enable an increase or decrease in the intervals between the plurality of comb teeth in the left-right direction, at least one of the plurality of lower base members may have one end hingedly coupled to one end of one of the plurality of upper base members and the other end hingedly coupled to the other end of another one of the plurality of upper base members.

In an embodiment of the present disclosure, at least a portion of the comb teeth protruding downward from the plurality of upper base members may be provided through overlapping portions of the plurality of lower base members, and the comb teeth may have a circular cross-section and serve as a hinge provided through the lower base members.

In an embodiment of the present disclosure, the hinge coupling may be achieved by a hinge function of the comb teeth.

In an embodiment of the present disclosure, a first upper base member positioned at the leftmost side among the plurality of upper base members has an extension length shorter than a second upper base member adjacent thereto on the right side; a third upper base member positioned at the rightmost side among the plurality of upper base members has an extension length shorter than a fourth upper base member adjacent thereto on the left side; a first lower base member positioned at the leftmost side among the plurality of lower base members has an extension length shorter than a second lower base member adjacent thereto on the right side; and a third lower base member positioned at the rightmost side among the plurality of lower base members has an extension length shorter than a fourth lower base member adjacent thereto on the left side. The first lower base member may have one end hingedly coupled to the other end of the first upper base member and the other end hingedly coupled to the other end of the second upper base member, and the third lower base member may have one end hingedly coupled to one end of the fourth upper base member and the other end hingedly coupled to the other end of the third upper base member.

In an embodiment of the present disclosure, the second lower base member may have one end hingedly coupled to one end of the first upper base member and the other end hingedly coupled to the other end of the second upper base member. The fourth lower base member may have one end hingedly coupled to one end of a fifth upper base member, which is adjacent to the left side of the fourth upper base member among the plurality of upper base members, and the other end hingedly coupled to the other end of the third upper base member.

The hair clip according to an embodiment of the present disclosure may further include a left handle protruding leftward from the first upper base member, and a right handle protruding rightward from the third upper base member.

In an embodiment of the present disclosure, each of the plurality of upper base members and the plurality of lower base members may be disposed such that both ends in an extension direction thereof are positioned lower than a center in the extension direction.

According to the present disclosure, a user may insert the comb teeth between strands of hair by placing the clip in an expanded state, and may cause the comb teeth to grip the hair by contracting the clip from the expanded state. At this time, since the height of the plurality of comb teeth increases as they are positioned closer to the longitudinal center of the upper base members and the lower base members, the hair may be lifted. Accordingly, root volume is created and the direction of hair growth can be corrected.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view of a hair clip according to an embodiment of the present disclosure;

FIG. 2 is a perspective view of the hair clip according to an embodiment of the present disclosure, viewed from a direction different from that of FIG. 1;

FIG. 3 is a perspective view of the hair clip according to an embodiment of the present disclosure, as viewed from below;

FIG. 4 is a plan view of the hair clip according to an embodiment of the present disclosure, as viewed from above, in a state where one upper base member is removed;

FIG. 5 is a perspective view of the hair clip according to an embodiment of the present disclosure, in an expanded state compared to FIG. 1;

FIG. 6 is a perspective view of the hair clip according to an embodiment of the present disclosure, as viewed from below, in an expanded state compared to FIG. 3;

FIG. 7 is a right-side view of the hair clip according to an embodiment of the present disclosure; and

FIG. 8 is a front view of the hair clip according to an embodiment of the present disclosure.

### DETAILED DESCRIPTION OF EXEMPLARY EMBODIMENTS

Hereinafter, embodiments of the present disclosure will be described in detail with reference to the accompanying drawings so that those of ordinary skill in the art to which the present disclosure pertains can easily implement them. However, the present disclosure may be implemented in various different forms and is not limited to the embodiments described herein. In the drawings, parts irrelevant to the description are omitted to clearly describe the present disclosure, and similar reference numerals are assigned to similar parts throughout the specification.

Throughout the specification of the present disclosure, when a part is said to be "coupled" to another part, this includes not only a case where they are "directly coupled" but also a case where they are "electrically coupled" with another element interposed therebetween.

Throughout the specification of the present disclosure, when a member is said to be located "on," "above," "at an upper end of," "under," "below," or "at a lower end of" another member, this includes not only a case where one member is in contact with another member but also a case where another member exists between the two members.

Throughout the specification of the present disclosure, when a part is said to "include" or "comprise" a component, it means that other components may be further included, rather than excluding other components, unless specifically stated to the contrary.

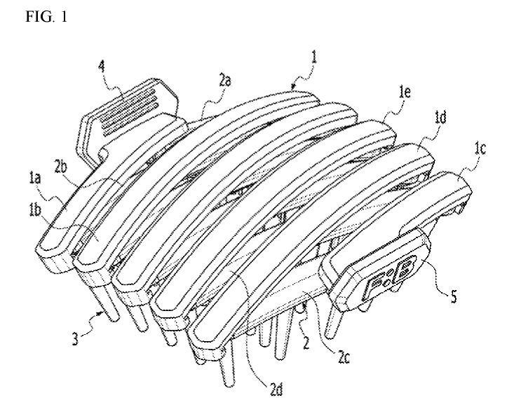

In addition, in the description of the embodiments of the present disclosure, terms related to direction or position (upper side, upper part, upper end, lower side, lower part, lower end, front, rear, left, right, etc.) are set based on the arrangement of each component shown in the drawings. For example, as viewed in FIG. 1, a direction generally toward 12 o'clock may be an upper side, a part generally toward 12 o'clock may be an upper part, an end generally toward 12 o'clock may be an upper end, a direction generally toward 6 o'clock may be a lower side, a part generally toward 6 o'clock may be a lower part, an end generally toward 6 o'clock may be a lower end, a 2 o'clock direction may be front, an 8 o'clock direction may be rear, a 10 o'clock direction may be left, and a 4 o'clock direction may be right.

The present disclosure relates to a hair clip.

Hereinafter, a hair clip according to an embodiment of the present disclosure (hereinafter referred to as "the present clip") will be described.

Referring to FIGS. 1-8, the present clip includes a plurality of upper base members 1.

Referring to FIG. 1, each of the plurality of upper base members 1 extends obliquely and is disposed adjacent to each other at intervals in the left-right direction.

In addition, referring to FIGS. 1-8, the present clip includes a plurality of lower base members 2 disposed below the plurality of upper base members 1.

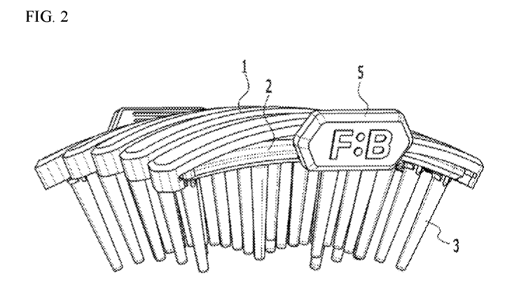

Referring to FIG. 2, the plurality of lower base members 2 extends to cross the extension direction of the plurality of upper base members 1 and is disposed adjacent to each other at intervals in the left-right direction.

That is, the plurality of upper base members 1 may be disposed at intervals in the left-right direction and may be arranged obliquely to form an angle with respect to the left-right direction. The plurality of lower base members 2 may be disposed at intervals in the left-right direction below the plurality of upper base members 1 and may be arranged obliquely such that their extension direction crosses the extension direction of the upper base members 1 while forming an angle with respect to the left-right direction.

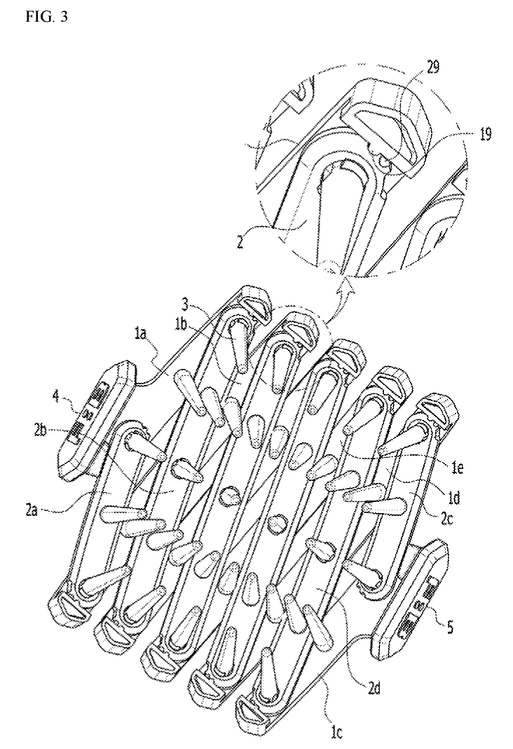

Further, referring to FIGS. 1-8, the present clip includes a plurality of comb teeth 3. Each of the comb teeth 3 may have a shape in which a cross-section thereof decreases toward a lower side. Referring to FIG. 3, the comb teeth 3 protrude downward from each of the plurality of upper base members 1 and the plurality of lower base members 2.

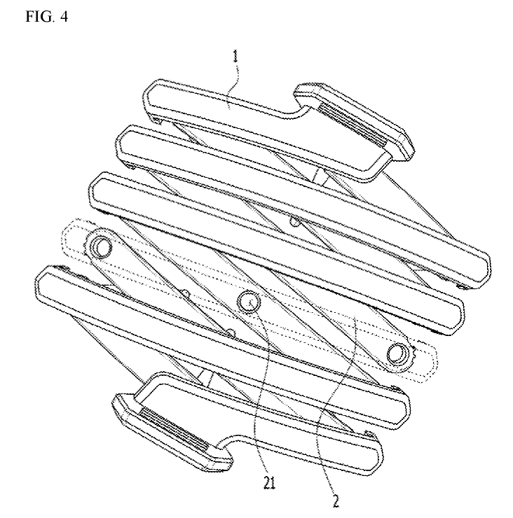

For example, referring to FIG. 3, the comb teeth 3 may be disposed at one end and the other end of each of the plurality of upper base members 1, and the comb teeth 3 may also be disposed at a longitudinal middle portion of each of the plurality of upper base members 1. In addition, at least a portion of the comb teeth 3 of the upper base members 1 may protrude downward through overlapping portions of the lower base members 2. To this end, referring to FIG. 4, a hole 21 through which the comb teeth 3 disposed on the upper base members 1 pass may be formed in the lower base members 2.

Additionally, referring to FIG. 3, the comb teeth 3 may be disposed on the lower base members 2 between the portions through which the comb teeth of the upper base members 1 pass.

Referring again to FIG. 3, at least a portion of the plurality of comb teeth 3 may be adjacent to each other in the left-right direction to form a group, and a plurality of such groups may be disposed.

Furthermore, referring to FIG. 3, the plurality of comb teeth 3 may be provided to extend in a direction toward the center of the present clip.

To enable an increase or decrease in the spacing between the plurality of comb teeth 3 in the left-right direction, at least one of the plurality of lower base members 2 may have one end hingedly coupled to one end of one of the plurality of upper base members 1 and the other end hingedly coupled to the other end of another one of the plurality of upper base members 1. In other words, to allow the spacing between the comb teeth 3 within a group to be adjusted in the left-right direction, at least one of the plurality of lower base members 2 may have one end hingedly coupled to one end of one of the plurality of upper base members 1 and the other end hingedly coupled to the other end of another one of the plurality of upper base members 1.

The specific details are described below. For reference, in the present disclosure, "one end" of the base members 1 and 2 may refer to a rear end, which is an end facing backward, and "the other end" may refer to a front end, which is an end facing forward.

Referring to FIG. 1, a first upper base member 1a, positioned at the leftmost side among the plurality of upper base members 1, may have an extension length shorter than a second upper base member 1b adjacent thereto on the right side. Additionally, a third upper base member 1c, positioned at the rightmost side among the plurality of upper base members 1, may have an extension length shorter than a fourth upper base member 1d adjacent thereto on the left side. In this case, the third upper base member 1c may be provided such that its front end is positioned further forward than the front end of the first upper base member 1a. Furthermore, the second upper base member 1b and the fourth upper base member 1d may be positioned between the first upper base member 1a and the third upper base member 1c, and if necessary, one or more other upper base members 1 may be provided. For example, a fifth upper base member 1e may be positioned adjacent to the left side of the fourth upper base member 1d.

In addition, referring to FIG. 3, a first lower base member 2a, positioned at the leftmost side among the plurality of lower base members 2, may have an extension length shorter than a second lower base member 2b adjacent thereto on the right side. Additionally, a third lower base member 2c, positioned at the rightmost side among the plurality of lower base members 2, may have an extension length shorter than a fourth lower base member 2d adjacent thereto on the left side. In this case, the third lower base member 2c may be provided such that its front end is positioned further backward than the front end of the first lower base member 2a. Furthermore, the second lower base member 2b and the fourth lower base member 2d may be positioned between the first lower base member 2a and the third lower base member 2c, and if necessary, one or more other lower base members 2 may be provided.

In addition, referring to FIG. 3, the first lower base member 2a may have one end hingedly coupled to the other end of the first upper base member 1a and the other end hingedly coupled to the other end of the second upper base member 1b. Further, the third lower base member 2c may have one end hingedly coupled to one end of the fourth upper base member 1d and the other end hingedly coupled to the other end of the third upper base member 1c.

Furthermore, the second lower base member 2b may have one end hingedly coupled to one end of the first upper base member 1a and the other end hingedly coupled to the other end of the second upper base member 1b.

In addition, the fourth lower base member 2d may have one end hingedly coupled to one end of a fifth upper base member 1e and the other end hingedly coupled to the other end of the third upper base member 1c.

Moreover, longitudinal middle portions of some of the plurality of upper base members 1 may be disposed to overlap with some of the plurality of lower base members 2, and the overlapping portions between the middle portions of the upper base members 1 and the lower base members 2 may be hingedly coupled to the lower base members 2.

The hinge coupling may be implemented as follows.

The hingedly coupled portion may be a portion where the comb teeth 3 of the upper base member 1 protrude downward while penetrating through the overlapping lower base member 2. That is, the comb teeth 3 may have a circular cross-section, which enables the hinge coupling. In other words, in the present disclosure, the hinge coupling may be achieved by the comb teeth 3, which protrude from the upper base members 1 and pass through the lower base members 2, serving as a hinge.

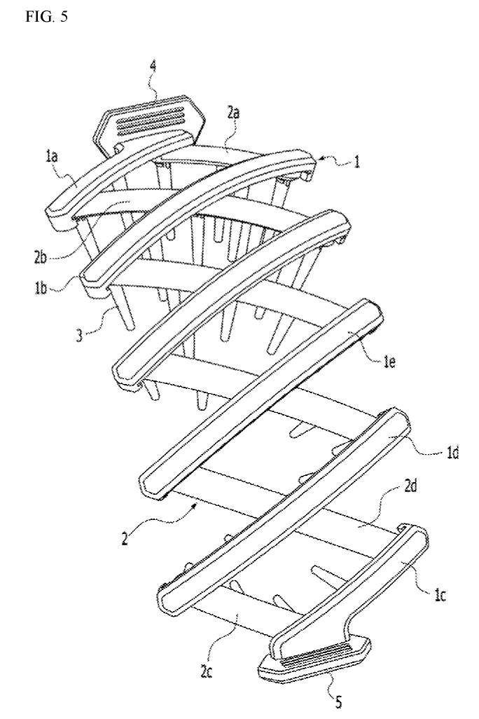

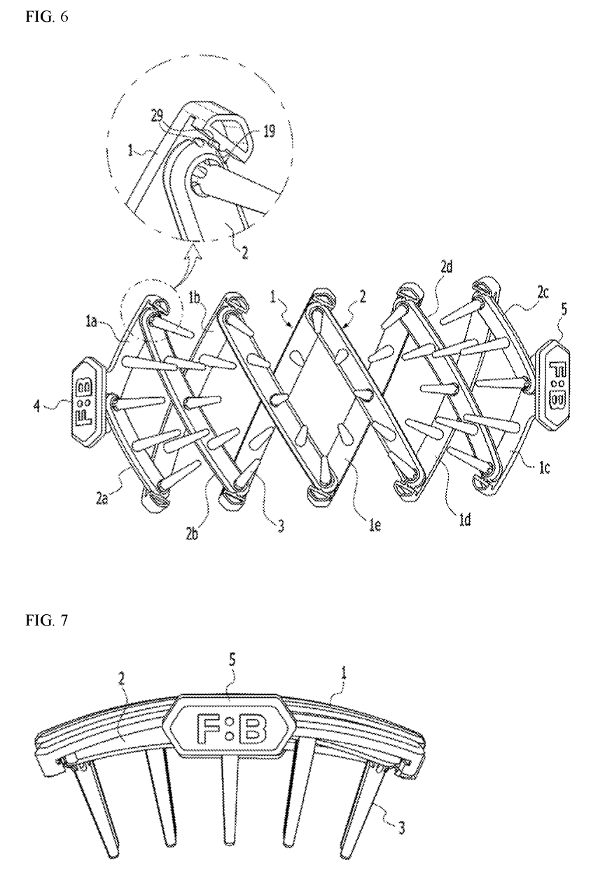

According to the foregoing, referring to FIGS. 5 and 6, when the first upper base member 1a and the third upper base member 1c are moved in directions away from each other, the present clip expands in the left-right direction due to the hinge coupling between the plurality of upper base members 1 and the plurality of lower base members 2, thereby increasing the spacing between the plurality of comb teeth in the left-right direction. Referring to FIGS. 1 and 2, when the first upper base member 1a and the third upper base member 1c are moved in directions toward each other, the expanded clip is contracted in the left-right direction due to the hinge coupling, thereby decreasing the spacing between the plurality of comb teeth 3 in the left-right direction.

Referring to FIGS. 3 and 6, a sawtooth portion including a plurality of grooves 29 recessed into a circumferential surface thereof may be formed at one end and the other end of each of the plurality of lower base members 2. Additionally, a protrusion 19, which protrudes toward an opposite side and is insertable into one of the grooves 29, may be formed at each of the one end and the other end of each of the plurality of upper base members 1. The protrusion 19 may be inserted into one of the plurality of grooves 29 of the sawtooth portion. When a change equal to or greater than a preset angle occurs in the crossing angle between the extension direction of the upper base members 1 and the extension direction of the lower base members 2, the protrusion 19 may be disengaged from the previously inserted groove 29 and then inserted into another groove 29. By inserting the protrusion 19 into the groove 29 as described above, the state of the present clip formed by the varying left-right interval between the first upper base member 1a and the third upper base member 1c can be fixed. Since there are a plurality of grooves 29, the left-right interval between the first upper base member 1a and the third upper base member 1c is adjustable, and accordingly, the state of the present clip is changeable. Also, referring to FIG. 3, at least one of the plurality of grooves may have a length longer than other grooves.

Referring to FIGS. 1-8, the present clip may include a left handle 4 protruding leftward from the first upper base member 1a and a right handle 5 protruding rightward from the third upper base member 1c. Accordingly, a user may place the present clip in an expanded state by gripping the left handle 4 and the right handle 5 and widening the spacing therebetween. Conversely, the user may place the present clip in a contracted state (a state where the spacing between the comb teeth 3 is reduced compared to the expanded state) by gripping the left handle 4 and the right handle 5 and reducing the spacing therebetween.

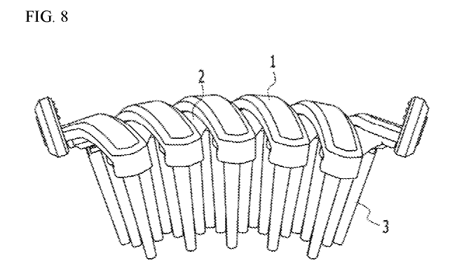

Furthermore, referring to FIGS. 7 and 8, each of the plurality of upper base members 1 and the plurality of lower base members 2 may be disposed such that both ends in an extension direction thereof are positioned lower than a center in the extension direction.

Specifically, referring to FIG. 7, each of the plurality of upper base members 1 may be formed in a curved shape that is positioned higher toward the center in its respective extension direction. These upper base members 1 may have a circular arc shape. Accordingly, the closer a comb tooth 3 is positioned to the longitudinal center of the upper base member 1, the higher it may be positioned relative to other comb teeth 3. According to this structure, the plurality of comb teeth 3 may be oriented toward a centripetal point, and the operational smoothness (reducing "creaking" or "jerking" sensitivity) during the transition between the expanded state and the contracted state of the present clip may be improved. Furthermore, since at least a portion of a human head may have a spherical curved surface, the clip may correspondingly grip the rounded portions of the head.

In addition, although not shown in detail in the drawings, referring to FIG. 8, each of the plurality of lower base members 2 may be provided in a curved shape that is positioned higher toward the center in its respective extension direction. These lower base members 2 may have a circular arc shape. Accordingly, the closer a comb tooth 3 is positioned to the longitudinal center of the lower base member 2, the higher it may be positioned relative to other comb teeth 3.

According to the present clip, a user may place the clip in an expanded state to insert the comb teeth 3 between strands of hair and may cause the comb teeth 3 to grip the hair by contracting the clip from the expanded state. At this time, since the height of the plurality of comb teeth 3 increases as they are positioned closer to the longitudinal center of the upper base members 1 and the lower base members 2, the hair may be lifted. Accordingly, root volume is created and the direction of hair growth may be corrected. A user may achieve the effect of forming root volume or correcting hair growth direction by removing the clip from the hair (e.g., moving it upward) while the hair is gripped by the clip. Alternatively, the user may blow-dry the hair while it is gripped by the clip. The present clip may be used in various other methods.

Additionally, for reference, referring to FIGS. 3 and 6, according to the present clip, the plurality of comb teeth 3 may form a quadrilateral (e.g., a rhombus), and this quadrilateral shape may be maintained in both the expanded state and the non-expanded state.

The foregoing description of the present disclosure is for illustrative purposes, and those of ordinary skill in the art to which the present disclosure pertains will understand that the present disclosure may be easily modified into other specific forms without changing its technical spirit or essential features. Therefore, it should be understood that the embodiments described above are illustrative in all respects and not restrictive. For example, each component described as a single type may be implemented in a distributed manner, and similarly, components described as being distributed may also be implemented in a combined form.

The scope of the present disclosure is defined by the following claims rather than the foregoing detailed description, and all changes or modifications derived from the meaning and scope of the claims and their equivalent concepts should be interpreted as being included in the scope of the present disclosure.

What is claimed is:

1. A hair clip comprising:
a plurality of upper base members, each extending obliquely and disposed adjacent to each other at intervals in a left-right direction;
a plurality of lower base members disposed below the plurality of upper base members, the plurality of lower base members extending to cross an extension direction of the plurality of upper base members and being disposed adjacent to each other at intervals in the left-right direction; and
a plurality of comb teeth protruding downward from each of the plurality of upper base members and the plurality of lower base members,
wherein, to enable an increase or decrease in spacing between the plurality of comb teeth in the left-right direction, at least one of the plurality of lower base members has one end hingedly coupled to one end of one of the plurality of upper base members and the other end hingedly coupled to the other end of another one of the plurality of upper base members.

2. The hair clip of claim 1,
wherein at least a portion of the comb teeth protruding downward from the plurality of upper base members is provided through overlapping portions of the plurality of lower base members, and
wherein the comb teeth have a circular cross-section and serve as a hinge provided through the lower base members.

3. The hair clip of claim 2,
wherein the hinge coupling is achieved by a hinge function of the comb teeth.

4. The hair clip of claim 1,
wherein a first upper base member positioned at a leftmost side among the plurality of upper base members has an extension length shorter than a second upper base member adjacent thereto on a right side,
wherein a third upper base member positioned at a rightmost side among the plurality of upper base members has an extension length shorter than a fourth upper base member adjacent thereto on a left side,
wherein a first lower base member positioned at a leftmost side among the plurality of lower base members has an extension length shorter than a second lower base member adjacent thereto on a right side,
wherein a third lower base member positioned at a rightmost side among the plurality of lower base members has an extension length shorter than a fourth lower base member adjacent thereto on a left side,
wherein the first lower base member has one end hingedly coupled to the other end of the first upper base member and the other end hingedly coupled to the other end of the second upper base member, and
wherein the third lower base member has one end hingedly coupled to one end of the fourth upper base member and the other end hingedly coupled to the other end of the third upper base member.

5. The hair clip of claim 4,
wherein the second lower base member has one end hingedly coupled to one end of the first upper base member and the other end hingedly coupled to the other end of the second upper base member, and
wherein the fourth lower base member has one end hingedly coupled to one end of a fifth upper base member, which is adjacent to the left side of the fourth upper base member among the plurality of upper base members, and the other end hingedly coupled to the other end of the third upper base member.

6. The hair clip of claim 4, further comprising:
a left handle protruding leftward from the first upper base member; and
a right handle protruding rightward from the third upper base member.

7. The hair clip of claim 1,
wherein each of the plurality of upper base members and the plurality of lower base members is formed such that both ends in an extension direction thereof are positioned lower than a center in the extension direction.
